(19) United States
(12) Patent Application Publication
(10) Pub. No.: US 2018/0189679 A1
(43) Pub. Date: Jul. 5, 2018

(54) SELF-LEARNING SYSTEM AND METHOD FOR AUTOMATICALLY PERFORMING MACHINE LEARNING

(71) Applicant: Electronics and Telecommunications Research Institute, Daejeon (KR)

(72) Inventors: Hyun Joong KANG, Jinju-si (KR); Hyun Jae Kim, Incheon (KR); Ho Sung Lee, Daejeon (KR); Soon Hyun Kwon, Incheon (KR); Kwi Hoon Kim, Daejeon (KR); Young Min Kim, Daejeon (KR); Eun Joo Kim, Daejeon (KR); Hong Kyu Park, Daejeon (KR); Ji Hoon Bae, Sejong-si (KR); Se Won Oh, Daejeon (KR); Jae Hak Yu, Daejeon (KR); Yeon Hee Lee, Daejeon (KR); Nae Soo Kim, Daejeon (KR); Sun Jin Kim, Daejeon (KR); Seong Ik Cho, Daejeon (KR); Cheol Sig Pyo, Sejong-si (KR)

(73) Assignee: Electronics and Telecommunications Research Institute, Daejeon (KR)

(21) Appl. No.: 15/859,937

(22) Filed: Jan. 2, 2018

(30) Foreign Application Priority Data
Jan. 3, 2017 (KR) 10-2017-0000689
Oct. 13, 2017 (KR) 10-2017-0133079

(51) Int. Cl. G06N 99/00; G06N 5/02

(52) U.S. Cl. CPC G06N 99/005; G06N 5/022

(57) ABSTRACT

Provided are a self-learning system and method for automatically performing machine learning (ML). The self-learning system includes a memory configured to store an ML knowledge database (DB) in which ML knowledge is stored and a program for automatically performing ML based on request information of a user, and a processor configured to execute the program stored in the memory. Here, when executing the program, the processor creates or recommends at least one workflow corresponding to the request information of the user based on the ML knowledge stored in the ML knowledge DB and generates an execution code for performing the created or recommended workflow.

### CROSS-REFERENCE TO RELATED APPLICATION

This application claims priority to and the benefit of Korean Patent Application No. 2017-0000689, filed on Jan. 3, 2017, and Korean Patent Application No. 2017-0133079, filed on Oct. 13, 2017, the disclosure of which is incorporated herein by reference in its entirety.

### BACKGROUND

### 1. Field of the Invention

The present invention relates to machine learning (ML), and more particularly, to a self-learning system and method for automatically performing ML which are capable of minimizing user intervention and required prior knowledge through a virtuous cycle of storing a ML workflow as structured knowledge, creating a new ML workflow based on the knowledge, and applying a result of executing the created ML workflow to the knowledge.

### 2. Discussion of Related Art

In general, expert knowledge is required to configure a ML workflow, and there are many difficulties for general users using a ML workflow.

In addition, according to related art, it is not easy to share information related to prior learning procedures, parameters, information resulting from it, and information on appropriate domains, features, or the like.

Consequently, according to the related art, there is a problem in that even ML experts themselves need to perform machine learning again while changing various attributes such as hyperparameters to obtain a desired or same result as others.

### SUMMARY OF THE INVENTION

The present invention is directed to providing a self-learning system based on machine learning (ML) knowledge and an automated workflow which is capable of minimizing user intervention and prior knowledge required to create a workflow through a virtuous cycle of storing knowledge related to ML, suggesting a standardized structure that is available for users of various levels, recommending an optimal workflow based on knowledge stored in a corresponding structure, and applying a result of executing the recommended workflow to the knowledge.

In particular, the present invention is directed to providing a self-learning system based on ML knowledge and an automated workflow which is capable of overcoming difficulties, which is caused by the technicality and step-by-step complexity of creating and determining a workflow, for a non-expert or a person who has not created a corresponding workflow in creating a workflow having the same effect.

According to an aspect of the present invention, there is provided a self-learning system for automatically performing ML, the system including: a memory configured to store an ML knowledge database (DB) in which ML knowledge is stored and a program for automatically performing ML based on request information of a user; and a processor configured to execute the program stored in the memory. Here, when executing the program, the processor creates or recommends at least one workflow corresponding to the request information of the user based on the ML knowledge stored in the ML knowledge DB and generates an execution code for performing the created or recommended workflow.

The ML knowledge DB may include at least one of user knowledge obtained by transforming scope of modification in workflow based on user type into knowledge, domain knowledge obtained by transforming scope of modification in workflow based on features of analysis-target domains into knowledge, guide knowledge in which information structures for generating workflow steps are defined, and workflow knowledge obtained by transforming applicable workflows based on user type and domain type into knowledge.

The processor may create at least one workflow corresponding to the request information of the user based on at least one of the user knowledge, the domain knowledge, the guide knowledge, and the workflow knowledge.

The user knowledge may be structured to include user type information, user operating environment information, and setting depth information for defining user-setting ranges of workflow or automatic-setting workflow ranges based on users and user type.

The domain knowledge may be structured to include domain type information and problem type information indicating a type of a problem to be solved by the domain type.

The guide knowledge may be structured to include at least one of location information knowledge, data condition knowledge, model restriction knowledge, execution restriction knowledge, and use-experience knowledge.

The location information knowledge may include at least one of a data storage location required to perform the workflow and an access route of a software package. The data condition knowledge may include at least one of a specific workflow for defining the workflow, a specific model element, and information on input and output data conditions of a specific class. The model restriction knowledge may include knowledge for restricting executable workflows or executable ML models. The execution restriction knowledge may include at least one of domain restriction knowledge, data restriction knowledge, memory restriction knowledge, and hardware restriction knowledge about a specific ML model. The use-experience knowledge may include at least one of a prediction type, frequencies of use of ML models, a label, and information about whether a label is necessary.

The guide knowledge may have an if-then-else structure with regard to the model restriction knowledge and the execution restriction knowledge, and the processor may automatically obtain the restriction knowledge through information on a result of performing the workflow.

The workflow knowledge include a plurality of nodes for defining individual unit functions constituting the workflow, attribute information of the nodes, and inter-node connection information.

The plurality of nodes may include at least two of a task starting node, a data processing node, a conditional branch node, and a task ending node.

The ML knowledge DB may further include logical knowledge obtained by transforming a function available in the workflow into knowledge. Here, the processor may concretize the created workflow to a logical knowledge level based on the logical knowledge.

The logical knowledge may be mapped to 0 or more entities of physical knowledge.

The ML knowledge DB may further include physical knowledge for defining model elements at a software library level available in the workflow. Here, the processor may generate the execution code of the workflow based on the physical knowledge.

The processor may collect the request information of the user including an analysis-target domain type and a user type requested to be analyzed, create or recommend at least one workflow corresponding to the request information of the user based on the ML knowledge DB, and generate the execution code based on the physical knowledge included in the ML knowledge DB.

Before generating the execution code, the processor may concretize the recommended at least one workflow to a logical knowledge level based on logical knowledge included in the ML knowledge DB, and convert the concretized workflow to an execution code level.

The processor may execute the at least one workflow based on the generated execution code and update the ML knowledge DB by feeding back a result of the at least one workflow.

When a workflow corresponding to the request information of the user is not in the ML knowledge DB, the processor may create a plurality of workflows applicable to the analysis-target domain type included in the request information of the user, analyze performance of the created workflows by comparing results of performing the workflows, and select and provide the at least one workflow to be recommended among the plurality of workflows.

According to another aspect of the present invention, there is provided a self-learning method for automatically performing ML, the method including: receiving request information of a user including a user type requested to be analyzed and an analysis-target domain type; creating or recommending at least one workflow corresponding to the request information of the user based on ML knowledge stored in an ML knowledge DB; and generating an execution code for performing the created or recommended workflow.

The ML knowledge DB may include at least one of user knowledge obtained by transforming workflow ranges based on user type into knowledge, domain knowledge obtained by transforming workflow ranges based on features of analysis-target domains into knowledge, guide knowledge in which information structures for generating workflow steps are defined, workflow knowledge obtained by transforming applicable workflows based on user type and domain type into knowledge, logical knowledge obtained by transforming functions available in the workflow into knowledge, and physical knowledge for defining model elements at a software library level available in the workflow.

The creating or recommending of the at least one workflow may include: creating at least one workflow corresponding to the request information of the user based on at least one of the user knowledge, the domain knowledge, the guide knowledge, and the workflow knowledge; and concretizing the created workflow to a logical knowledge level based on the logical knowledge. Here, the generating of the execution code may include generating the workflow execution code concretized to the logical knowledge level based on the physical knowledge.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram showing a basic configuration of a self-learning system based on machine learning (ML) knowledge and an automated workflow according to an exemplary embodiment of the present invention;

FIG. 2 is a diagram illustrating a structure of an ML knowledge database (DB) in a self-learning system based on ML knowledge and an automated workflow according to an exemplary embodiment of the present invention;

FIGS. 3A and 3B are diagrams illustrating user knowledge and domain knowledge in a self-learning system based on ML knowledge and an automated workflow according to an exemplary embodiment of the present invention;

FIGS. 4A to 4C are diagrams illustrating workflow knowledge abstracted by a self-learning system based on ML knowledge and an automated workflow according to an exemplary embodiment of the present invention;

FIG. 5 is a diagram illustrating a relationship between logical knowledge and physical knowledge in a self-learning system based on ML knowledge and an automated workflow according to an exemplary embodiment of the present invention;

FIGS. 6A and 6B are a diagram illustrating a process of creating a workflow in a self-learning system based on ML knowledge and an automated workflow according to an exemplary embodiment of the present invention;

FIG. 7 is a diagram illustrating differentiated recommendation examples of workflows based on user type and domain type in a self-learning system based on ML knowledge and an automated workflow according to an exemplary embodiment of the present invention;

FIGS. 8A and 8B are a sequence diagram illustrating operation of a self-learning system based on ML knowledge and an automated workflow according to an exemplary embodiment of the present invention; and

FIG. 9 is a diagram showing a configuration of a self-learning system according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. However, a detailed description of a known art or element which may obscure the gist of the present invention will be omitted in the following description and the accompanying drawings. This is intended not to obscure the gist of the present invention but to convey the gist of the present invention more clearly by omitting unnecessary description. Throughout the drawings, like elements are noted by like reference numerals as much as possible.

Terms or words used in this specification and claims are not to be construed as common or dictionary meanings but are to be construed as meanings and concepts in accordance with the technical spirit of the present invention based on a principle that the inventor may define terms appropriately for beast explaining his or her own invention. Therefore, embodiments described in the present specification and configurations shown in the drawings are merely exemplary embodiments of the present invention and do not represent the whole technical spirit of the present invention. Thus, it is to be understood that there can be various equivalents and modifications at the filing date of the present invention.

Although terms including ordinal numbers, such as “first,” “second,” and the like, may be used to describe various elements, the elements should not be defined by such terms. Such terms are used only for the purpose of distinguishing one element from another. For example, a first element may be designated a second element without departing from the scope of the present invention and, similarly, the second element may also be designated the first element.

It will be understood that when an element is referred to as being “connected” or “coupled” to another element, the element may be logically or physically connected or coupled to the other element. In other words, the element may be connected or coupled to the other element directly or indirectly, or intervening elements may be present.

The terminology used herein to describe particular embodiments is not intended to limit the scope of the present invention. Elements referred to in the singular may number one or more, unless the context clearly indicates otherwise. It will be further understood that the terms “comprise,” “include,” or the like, when used herein, specify the presence of stated features, numbers, steps, operations, elements, parts, or combinations thereof, but do not preclude the presence or addition of one or more other features, numbers, steps, operations, elements, parts, or combinations thereof.

The present invention is intended to allow, based on machine-learning (ML) knowledge, various types of users to automatically create workflows appropriate for domains of various fields and implement the created workflows using various algorithms.

ML is a field of artificial intelligence (AI) and may be said to be a series of processes for finding formulas that describe given data.

The core of ML is representation and generalization. Here, representation denotes data evaluation, and generalization denotes processing of new data given after learning that is not yet understood. The given data may or may not include an answer. When an answer is given, a process of predicting a meaning of the provided data, comparing a predicted value and the answer, and then updating a prediction function with a difference therebetween is repeatedly performed. Here, a series of processes for finding a formula which describes data by performing ML is modularized according to functional element, and the modules are connected to each other. This is referred to as ML workflow (will be referred to as workflow below).

To create such a workflow, it is necessary not only to understand various ML terms but also to deeply understand ML-related technology.

In particular, a workflow includes a process of data preprocessing, learning, evaluation, prediction, transformation into knowledge, searching, and the like. Various workflows may have the same purpose, and specialized knowledge and great efforts are required to determine an optimal workflow by comparing various workflows.

A process which is most important and consumes the longest time in ML is a feature engineering process, a model optimization process, or an optimal model selection process based on millions or more of features or attributes.

Meanwhile, a workflow in an exemplary embodiment of the present invention denotes an overall process of performing ML. A workflow may include data collection, data preprocessing, ML, ML evaluation, verification of ML results, a prediction based on ML results, and a transformation of information obtained in the workflow into knowledge.

For example, a workflow defines an overall process of collecting data in a storage or a device in real time or in batches, preprocessing the data to replace empty values, converting literal values into numerical values which are calculable by a computer, learning the results to classify the results into five types, making a prediction using models resulting from the learning and new data which are also calculable by a computer, and applying additional data generated in each process to knowledge again through relationship inference, establishment of a new relationship, and the like.

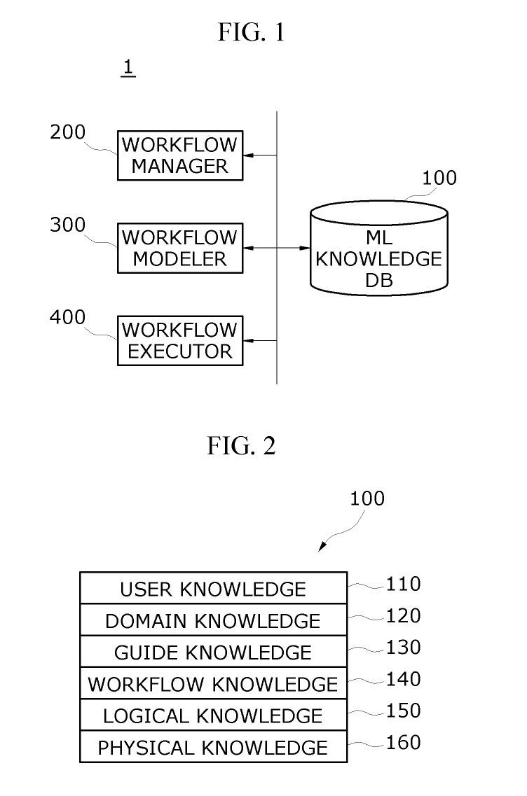

First, an overall configuration of a self-learning system 1 according to an exemplary embodiment of the present invention will be briefly described with reference to FIG. 1.

FIG. 1 is a block diagram showing a basic configuration of a self-learning system 1 based on ML knowledge and an automated workflow according to an exemplary embodiment of the present invention.

Referring to FIG. 1, the self-learning system 1 according to an exemplary embodiment of the present invention includes an ML knowledge database (DB) 100, a workflow manager 200, a workflow modeler 300, and a workflow executor 400.

The self-learning system 1 according to an exemplary embodiment of the present invention transforms a workflow into knowledge through those elements and creates a workflow appropriate for a user type and a domain type using the knowledge. Also, the self-learning system 1 concretizes the created workflow using various algorithms, converts the concretized workflow to an execution code level, executes the workflow, and transforms the execution results into knowledge as well.

The ML knowledge DB 100 is an aggregate of ML knowledge including all information which is selectable to perform ML. Specifically, when a workflow is abstracted and the abstracted workflow is classified based on user and domain type and transformed into knowledge, related knowledge for implementing each function of the abstracted workflow is stored in the ML knowledge DB 100.

For example, the ML knowledge DB 100 includes knowledge related to software for creating a workflow, knowledge related to an algorithm for creating a workflow, domain-specific knowledge for creating a workflow, purpose-specific knowledge for creating a workflow, relationships between pieces of the domain-specific knowledge, data used in ML, knowledge to which results of performing a workflow is applied, evaluation information of a workflow, and the like. Such knowledge may be constructed in any way in which it is possible to structure and store knowledge, for example an ontology, a relational DB (RDB), a resource description format (RDF) repository, and a file system. The constructed knowledge includes a structure of abstracted information (a schema, an ontology, or the like) and an instance of the structure.

FIG. 2 is a diagram illustrating a structure of the ML knowledge DB 100 in the self-learning system 1 based on ML knowledge and an automated workflow according to an exemplary embodiment of the present invention.

Referring to FIG. 2, knowledge for automation of workflows stored in the ML knowledge DB 100 according to an exemplary embodiment of the present invention may include at least one of user knowledge 110, domain knowledge 120, guide knowledge 130, workflow knowledge 140, logical knowledge 150, and physical knowledge 160. Here, each of the user knowledge 110, the domain knowledge 120, the guide knowledge 130, the workflow knowledge 140, the logical knowledge 150, and the physical knowledge 160 may have relationships with one or more other pieces of knowledge.

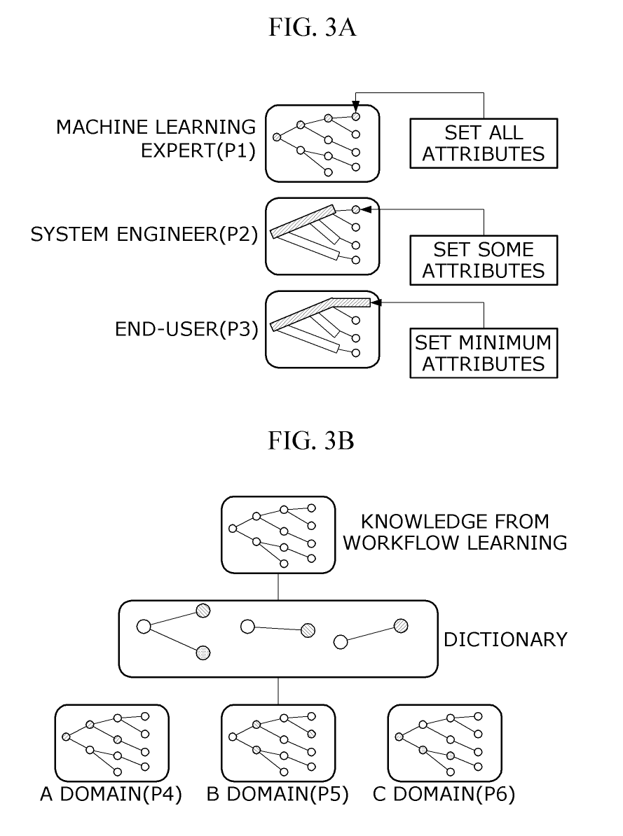

Pieces of structured knowledge in the ML knowledge DB 100 and relationships therebetween will be described in detail below with reference to FIGS. 3 to 5.

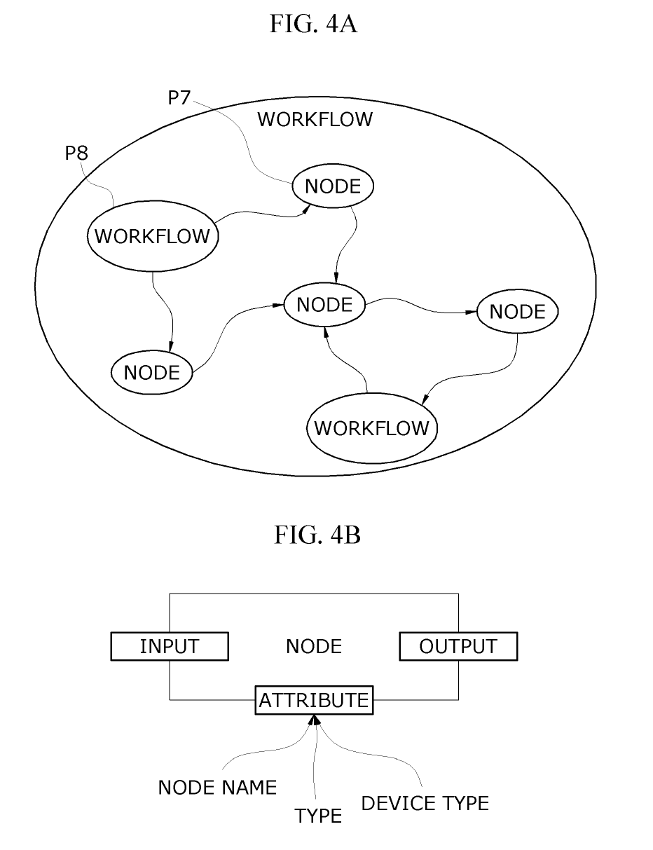

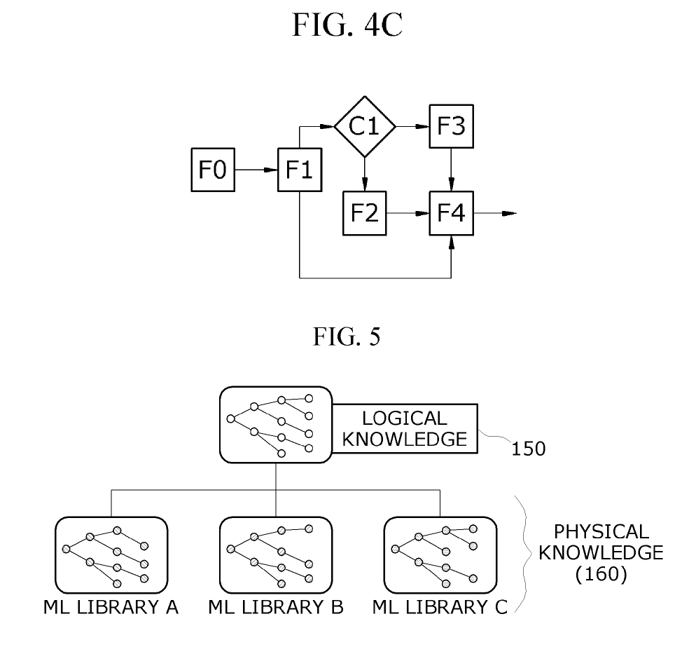

FIGS. 3A and 3B are diagrams illustrating user knowledge and domain knowledge in the self-learning system 1 based on ML knowledge and an automated workflow according to an exemplary embodiment of the present invention. FIGS. 4A to 4C are diagrams illustrating workflow knowledge abstracted by the self-learning system 1 based on ML knowledge and an automated workflow according to an exemplary embodiment of the present invention. FIG. 5 is a diagram illustrating a relationship between logical knowledge and physical knowledge in the self-learning system 1 based on ML knowledge and an automated workflow according to an exemplary embodiment of the present invention.

First, the user knowledge 110 is obtained by transforming workflow ranges based on user type into knowledge and includes information on user types, setting depths, and user operating environments.

Here, the information on user types is classified according to levels of ML- and domain-related knowledge. For example, user types may include a general user, a system engineer, an ML expert, and the like. To this end, the user knowledge 110 may include general user knowledge and functions of ML knowledge, which are redefined with different structures according to user level.

The information on setting depths defines for which steps a user setting will be allowed in an entire workflow and for which steps an automatic setting will be made based on knowledge, according to an ML knowledge level of a corresponding user type.

The information on user operating environments includes information on hardware and operating systems (OSs) of users.

For example, referring to FIG. 3A, an ML expert P1 may be allowed to set all attributes of individual functions of a workflow. On the other hand, a system engineer P2 may be allowed to set some attributes, and a minimum attribute-setting range may be provided to a general user P3 so that user intervention is as unnecessary as possible.

In this way, with regard to creation of a specific workflow, ranges of attribute information which may be set by users based on user type (e.g., an expert, a system engineer, a general user, and the like) may be transformed into knowledge and defined in the user knowledge 110.

Next, the domain knowledge 120 is obtained by transforming detailed workflow ranges according to domain features of a field to which ML is applied into knowledge. The domain knowledge 120 includes ML functions which are redefined with other structures according to domains.

Specifically, the domain knowledge 120 is structured to include information on domain types and problem types.

The problem types represent types of problems to be solved through ML. For example, problem types may be classified into a supervised learning type, an unsupervised learning type, a reinforcement learning type, and the like, or may be classified into a clustering type, a regression analysis type, a classification type, and the like according to other criteria.

Here, the domain knowledge 120 is obtained by transforming ML-related information classified based on type of domain to which ML is applied, and may include terms related to workflows used in individual domains. Also, the domain knowledge 120 may include information for mapping the ML functions or attributes to corresponding functions or attributes when ML functions or attributes of the same purpose are used in different ways according to domain type.

Therefore, as shown in FIG. 3B, the self-learning system 1 according to an exemplary embodiment of the present invention may represent individual workflows in different ways based on the domain knowledge 120 by applying language or terminology used in different ways in each ML based on domain type (P4 to P6).

Next, the guide knowledge 130 is obtained by defining information structures and limiting conditions for creating a workflow in stages as knowledge.

Specifically, the guide knowledge 130 is structured based on representative functions for problems to be solved. Accordingly, as the guide knowledge 130, an ML workflow or functions which are determined according to an input provided by a user may be abstracted to workflows based on the workflow knowledge 140 and converted into model elements based on the logical knowledge 150. Also, the guide knowledge 130 may include knowledge required to appropriately perform a process of converting a class based on the physical knowledge 160.

Specifically, the guide knowledge 130 may include location information knowledge, data condition knowledge, model restriction knowledge, execution restriction knowledge, and use-experience knowledge.

The location information knowledge may include a data storage location required to perform a workflow, an access route of a software package, and the like.

The data condition knowledge may include a specific workflow for defining a workflow, a specific model element, input and output data conditions of a specific class, and the like.

The model restriction knowledge may include knowledge for restricting executable workflows or executable ML models. For example, when no label corresponds to an answer for image recognition data, the model restriction knowledge may impose a restriction “There is no appropriate model” or “It is not possible to select a regression model for image classification.” In other words, only targets that are available according to the features of the data and the problem are provided as abstractable targets.

The execution restriction knowledge may include domain restriction knowledge, data restriction knowledge, memory restriction knowledge, and hardware restriction knowledge, and the like about a specific ML model (which may correspond to a specific node, a specific model element, or a specific class). The domain restriction knowledge is intended to restrict domains to which ML models may be applied, and the data restriction knowledge is intended to restrict data which may be input or output by ML models. The memory restriction knowledge is intended to restrict minimum memory required to execute ML models, and the hardware restriction knowledge is intended to restrict hardware in which ML models may be executed.

The use-experience knowledge may include information such as a prediction type, a frequency of use of an ML model, a label, whether a label is necessary, and the like. The prediction type denotes a type of information to be predicted through ML, and the type of information may include at least one of true or false, quality, quantity, values, structure, anomaly, and category. The frequency of use of an ML model denotes the number of times a specific ML model (which may correspond to a specific node, a specific model element, or a specific class) is used. The label corresponds to an answer in ML, and after solving a problem, it is possible to calculate a difference between a result derived from ML and the answer defined by the label and compensate for a procedure for solving the problem. The prediction type and the frequency of use of an ML model of the guide knowledge 130 may be connected to workflow knowledge 140 which is frequently used according to prediction type.

The guide knowledge 130 may have an if-then-else structure with regard to structured restrictions. For example, with regard to an image recognition problem, the guide knowledge 130 may be structured like “when a sample size of input data is smaller than 100 Mb, it is not possible to use a deep learning algorithm.” Such a restriction may be automatically transformed into knowledge based on result information generated by executing a workflow, or a basic structure of a restriction may be generated through settings set by an expert and then the restriction may be automatically updated based on management records.

The workflow knowledge 140 represents abstracted workflows which are applicable according to user type and domain type by means of nodes and links. Here, each workflow may be associated with a specific user type and domain type defined in the user knowledge 110 and the domain knowledge 120.

In the workflow knowledge 140 according to an exemplary embodiment of the present invention, a workflow W is defined to be a workflow which connects one or more ML function elements for the workflow to each other using units of nodes P7 as shown in FIG. 4A. The nodes P7 are units for defining individual functions constituting the workflow, and flow between nodes may be generated by connecting a plurality of nodes through input and output. One workflow P8 may include a task starting node, a data processing node, a conditional branch node, a task ending node, and the like. The workflow P8 may further include description information of the workflow. Meanwhile, limiting conditions required to execute all nodes included in the workflow P8 are defined based on guide knowledge.

Here, the task starting node is a node at which a task is initially started, and the task ending node is a node at which the task finally ends. The data processing node functions to receive a result output by at least one node and output the result to at least one node. The conditional branch node functions to receive a result output by at least one node, make a determination of a condition, and selectively output the received result to at least two nodes.

The nodes P7 perform an operation for one computation, and as shown in FIG. 4B, data is input and output at two edges of each node P7.

Also, as shown in FIG. 4B, nodes include information for describing computation operations together with input and output. Information that may be included in nodes may be node names, type information, category information, and various attributes and parameter information which specify computation operations.

As shown in FIG. 4C, node types may be classified as a task starting node F0, data processing nodes F1, F2, and F3, a conditional branch node C1, a task ending node F4, and the like. Here, a node having no input edge is the task starting node F0, and a node having no output edge is the task ending node F4. A node whose functional type is defined to receive at least one input and branch to at least two nodes is the conditional branch node C1. Nodes which are not conditional branch nodes and have both input and output edges are the data processing nodes F1, F2, and F3 which receive an input through at least one input edge, perform a function according to a function type, and make an output through the output edge.

Input edges of the nodes P7 may include information such as input data sets of the nodes P7, input conditions, descriptions of input data features, input node identifiers, input names, input types, input formats, and the like. Output edges may include information such as output data sets of the nodes P7, output conditions, descriptions of output data features, output node identifiers of the nodes P7, output names, output types, output formats, and the like. Definitions of functions of the data processing nodes F1, F2, and F3 may include function identifiers, function types, function names, and the like. Attributes may include node identifiers, node names, hardware device types capable of performing functions, execution count information, and the like. Here, the execution count information is a numerical value indicating how many times a corresponding workflow is executed, and may be stored separately based on use-target distinguishers such as users, domains, and the like.

The description information of the workflow may include information related to the workflow such as a keyword, a name, an identifier, a creator, a created time, a last modified time, a supported ML engine, a related problem, a relevance rate, and the like.

Here, the related problem information may denote a problem type associated with the workflow, and the relevance rate may denote the degree of association or similarity to a specific function or type. Based on the guide knowledge 130 related to the related problem information, it is possible to search for an appropriate workflow.

Next, the logical knowledge 150 is intended to convert a node of a workflow into at least one model element while conforming to limiting conditions of the guide knowledge 130. Such logical knowledge 150 is obtained by transforming functions, which may be used in a workflow that includes data collection for the workflow, data preprocessing, ML, prediction based on ML results, and the like, into knowledge, and defines model elements used in the workflow at a terminology level. For example, “Ensemble algorithms include Random Forest, Gradient Boosting Machines, AdaBoost, Gradient Boosted Regression Trees, etc.” and the like may be structured as the logical knowledge 150.

Specifically, the logical knowledge 150 may include function information, description information, and the like of each node. Each function defined in the logical knowledge 150 has parent-child relationship information, and it is possible to distinguish similar groups based on categories, families, groups, and the like.

The description information of the logical knowledge 150 may include information on a corresponding model element, such as a name, an identifier, a version, an owner, users, a created time, a last modified time, and the like.

The function information of the logical knowledge 150 may include hierarchical structure information defined as a relationship between parent and child functions required to define ML functions. Structure information of each hierarchy may include connection information about upper and lower hierarchies, relatable domain information, a type, an identifier, a name, a description, and the like. The relatable domain information is defined only when domains in which it is possible to use a specific function or a hierarchical structure including the specific function are limited.

Also, the function information of the logical knowledge 150 may include at least one of data source information for defining data locations and access methods, data gathering information for defining how to collect data, data sampling information for examining collected data information, data preprocessing information for vectorizing the collected data, learning information for performing learning based on the vectorized data, learning test information for verifying whether learning is done well, learning evaluation information, prediction information for determining new data using a learning model derived from a learning result, and save-as-knowledge information for storing knowledge improved through overall function or newly found knowledge.

In addition, each model element of the logical knowledge 150 may be matched to 0 or more entities of the physical knowledge 160 as shown in FIG. 5. When the logical knowledge 150 is matched to 0 pieces of the physical knowledge 160, no piece of the physical knowledge 160 is matched to a corresponding function. In this case, a user may add a piece of the physical knowledge 160 corresponding to the function. A piece of the physical knowledge 160 indicated by the model element may vary depending on a constitution of a task knowledge set and a feature or structure of an ML engine constituting the physical knowledge 160.

Finally, the physical knowledge 160 is intended to convert model elements of the logical knowledge 150 into one or more classes with respect to a specific software package while conforming to the limiting conditions of the guide knowledge 130. The model elements are obtained by defining functions available in a workflow, which includes data collection for the workflow, data preprocessing, ML, prediction based on ML results, and the like, at a logical level.

Meanwhile, the self-learning system 1 according to an exemplary embodiment of the present invention may generate one or more model elements by applying the limiting conditions of the guide knowledge 130 and the logical knowledge 150 to workflow nodes, and convert the model elements into one or more classes by applying the limiting conditions of the guide knowledge 130 and the physical knowledge 160 to the model elements. Here, the classes are obtained by converting a data processing process performed by the workflow into control codes or execution codes of a specific software package.

The physical knowledge 160 may include a code conversion knowledge dictionary required to convert model elements of the logical knowledge 150 into classes. The code conversion knowledge dictionary may include class information required to apply a specific model element to a specific software package.

In the class information, no class may be designated for a specific model element, only one class may be designated, or a task process composed of two or more classes may be designated. When no class is designated, no class in a corresponding software package corresponds to the specific model element. In this case, a user may add a class according to a corresponding function, and the added class is automatically registered in the physical knowledge 160 such that knowledge is enhanced.

The physical knowledge 160 may include description information and attribute information of software packages which are targets of code conversion and class information for defining constitutions of the software packages. Each software package included in the physical knowledge 160 may be composed of one or more classes. Each class may be composed of one or more functions, and each function may include one or more arguments. The physical knowledge 160 may be obtained by structuring such description information, class information, function information, argument information, and the like.

The description information may include information about a corresponding software package such as a name, an identifier, a version, functional specifications, an installation location, an organization, a supported OS, a supported device type, an application program interface (API) wrapper language, and the like.

The attribute information may include an abstraction type, whether the code-converted software package coincides with the original, a history of code conversion performed, history-specific result information, and the like.

The class information may include class identifiers, class names, function types, scores, parent classes, child classes, categories, argument identifiers, argument names, argument orders, argument descriptions, return types, return names, return descriptions, and the like.

Here, the organization information included in the description information may include a software development company of the software package, a support group for providing technical support for the software package, and the like. Also, the supported device type information may include information central processing unit (CPU) information, graphics processing unit (GPU) information, tensor processing unit (TPU) information, application-specific integrated circuit (ASIC) information, field programmable gate array (FPGA) information, neuromorphic or neurosynaptic chip information, and the like. The API wrapper language information may include information on a language such as Java, Python, Scala, and the like, in which a corresponding API is described. Meanwhile, functions constituting a class may include input argument information, task-performing function information, output argument information, and the like.

The self-learning system 1 according to an exemplary embodiment of the present invention may convert nodes of a workflow into model elements based on the logical knowledge 150 and convert the model elements into classes based on the physical knowledge 160.

Also, the self-learning system 1 according to an exemplary embodiment of the present invention may verify validity of a final ML control code or execution code generated based on the physical knowledge 160.

Here, validity verification may be performed by applying, to a software package in which the ML control code or execution code will be executed, a specific data set designated by a provider of the software package or by a user and an ML environment defined in the guide knowledge 130.

Here, the specific data set may include a de facto standard data set which is widely used in a process of developing an ML model, a training and evaluation data set which is used by a provider or a user, and the like.

The self-learning system 1 according to an exemplary embodiment of the present invention may perform a workflow by applying a code whose validity has been completely verified to a software package. Here, a control code or execution code generated to perform the workflow is executed in conjunction with an ML engine, a data processing engine, a data storage engine, and a DB management system.

The ML engine denotes a software package capable of performing an ML function. For example, widely used ML packages are Cloudera Oryx, CUDA-Convnet, SciPy, and the like, and deep learning packages are TensorFlow, Caffe, Theano, Keras, and the like.

Examples of the data processing engine, which is a software package capable of processing a large amount of data, are Hadoop MapReduce, Spark, and the like.

Examples of the data storage engine, which is a software package capable of performing functions, such as data insertion, extraction, update, deletion, and the like, are Hbase, Cassandra, MongoDB, Apache Jena, and the like.

The DB management system denotes a software package capable of performing a function of accessing data stored in a DB.

In the above description, structured information of each piece of knowledge is exemplary and may be added and updated as workflows are further diversified and become more complicated.

The ML knowledge DB 100 having the above-described structure may be constructed by a user or a preset ML apparatus for transformation into knowledge.

Referring back to FIG. 1, the workflow manager 200 is an element for creating a workflow and managing, analyzing, and updating the created workflow. Specifically, the workflow manager 200 collects a user request through interaction with a user, creates at least one workflow according to the user request based on knowledge of the ML knowledge DB 100, and provides the created workflow to the user. For interaction with a user, the workflow manager 200 may include a function of interpreting a language or an action of a person, for example, neuro-linguistic programming (NLP) and the like. In addition, the workflow manager 200 receives workflow information and execution results from the workflow modeler 300 and the workflow executor 400 and updates the ML knowledge DB 100.

The workflow modeler 300 generates an ML model by concretizing the at least one workflow created by the workflow manager 200 based on the logical knowledge 150. Here, information on the workflow modeled by the workflow modeler 300 is fed back to the workflow manager 200 for a transformation into knowledge.

The workflow executor 400 is an element for executing the at least one workflow concretized by the workflow modeler 300. Specifically, the workflow executor 400 converts the modeled workflow to the execution code level using the physical knowledge 160 based on a library of an ML engine, allocates resources required to perform ML, and executes the workflow. In addition, when execution of the workflow is completed, the workflow executor 400 feeds back the execution results and an event log to the workflow manager 200 so that the workflow may be transformed into knowledge.

Here, for the purpose of evaluation and management, the workflow executor 400 may collect and feedback an overall history of performing ML, a history of iteration results occurring in each component, an total delay time, a delay history of each component, an error history, input and output values of each component, state information, and the like to the workflow manager 200.

Also, the workflow executor 400 may simultaneously generate and execute a plurality of workflows, generate execution results of each workflow, map attributes automatically or according to user definitions, and provide comparison information.

In the self-learning system 1 having such a configuration, each element constituting a workflow is stored as ML knowledge in the ML knowledge DB 100 and may be provided at different levels according to the type of user who wants to create a workflow, an applied domain, and the like.

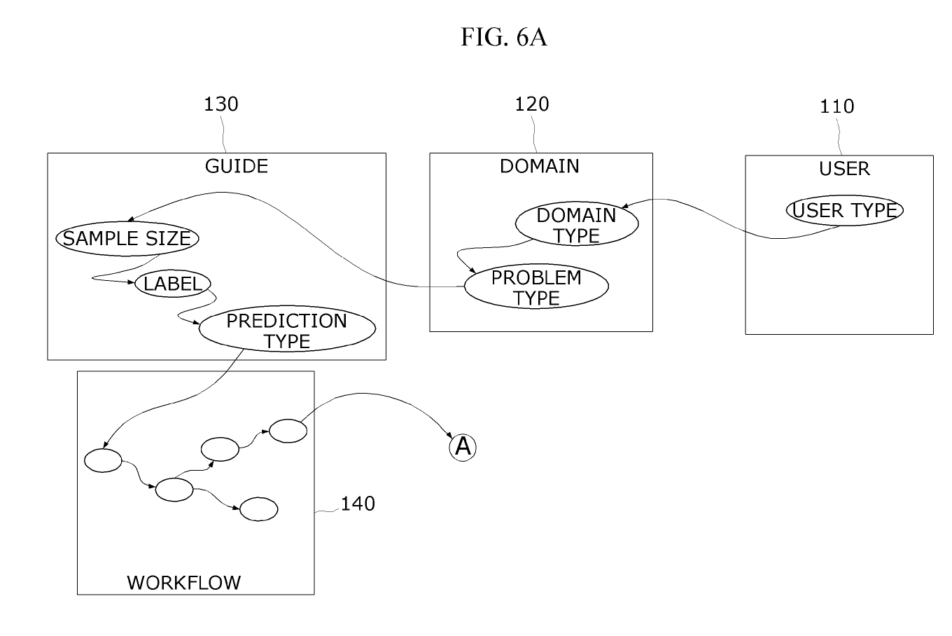

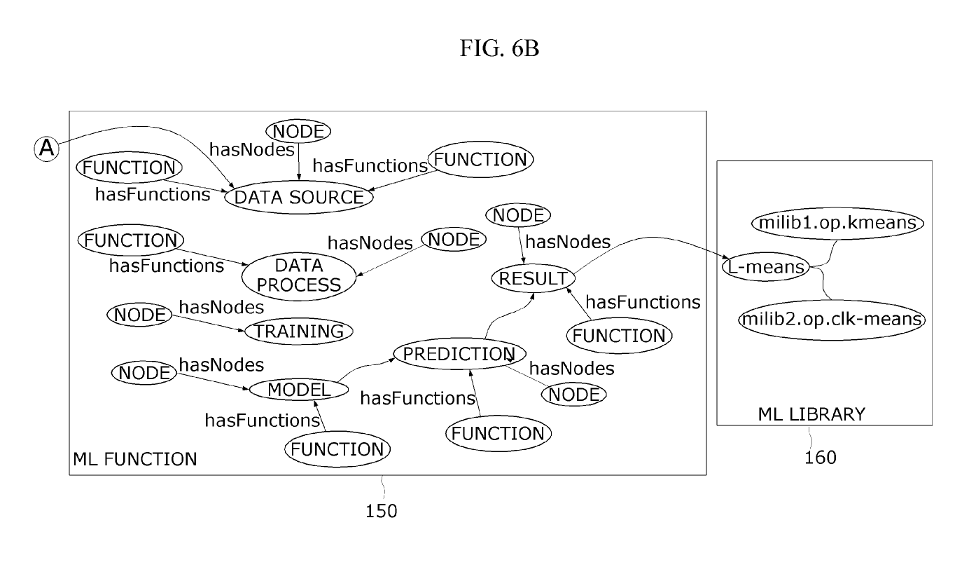

A process of creating a workflow based on the ML knowledge DB 100 in the self-learning system 1 configured as described above will be described with reference to FIG. 6.

FIGS. 6A and 6B are a diagram illustrating a process of creating a workflow in the self-learning system 1 based on ML knowledge and an automated workflow according to an exemplary embodiment of the present invention.

A user of the self-learning system 1 according to an exemplary embodiment of the present invention may input a user request that includes user type information about himself or herself, who wants to perform ML and domain information of an application field, and instruct the self-learning system 1 to create a workflow. The user request is input to the workflow manager 200.

Then, the workflow manager 200 creates at least one workflow appropriate for the user type and the domain type based on the user knowledge 110, the domain knowledge 120, and the guide knowledge 130 of the ML knowledge DB 100.

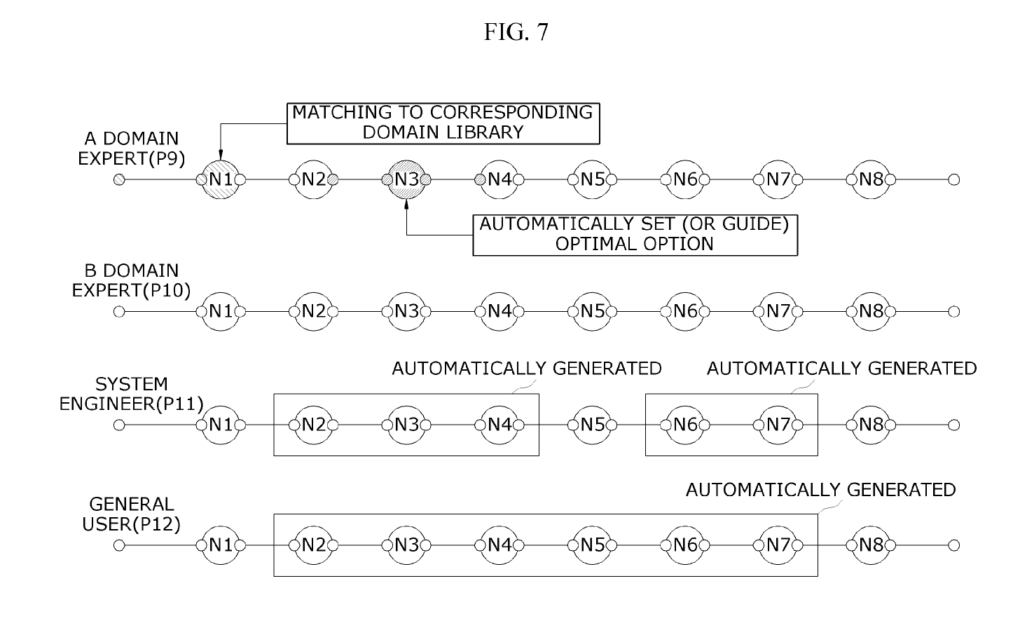

FIG. 7 is a diagram illustrating differentiated recommendation examples of workflows based on user type and domain type in the self-learning system 1 based on ML knowledge and an automated workflow according to an exemplary embodiment of the present invention.

When a workflow is obtained by connecting nodes N1 to N8, an attribute and an option of each node are provided to a Domain B expert P10 as they are so that the corresponding expert may set the attributes and the options. However, for Domain A expert P9, a specific node N1 may be matched to a library of Domain A, and arbitrary another node N3 may be automatically set or guided to an optimal option.

Also, when a user type is a system engineer P11, some nodes N2 to N4 and N6 and N7 in the workflow are automatically set and provided. On the other hand, when a user type is a general user P12, most nodes N2 to N7 of the workflow are automatically generated and provided such that a corresponding user may be supported according to his or her user level.

Each node of the workflow generated in this way is concretized to a logical knowledge 150 which is a logical function level by the workflow modeler 300 as shown in FIG. 6, and each function is converted to the execution code level using a library of physical knowledge 160 matched to the function by the workflow executor 400.

The workflow converted to the execution code level in this way is executed by the workflow executor 400. When execution of the workflow is completed, processing results of the workflow modeler 300 and the workflow executor 400 may be transformed into knowledge by the workflow manager 200 and stored in the ML knowledge DB 100.

Subsequently, when another user wants to make a workflow plan with the same scenario, it is possible to provide an improved version of the workflow plan to the other user. Here, the workflow plan includes a goal and an expected result of ML. Since one or more ML functions may satisfy the goal and the expected result, one or more workflows may be present for one workflow plan.

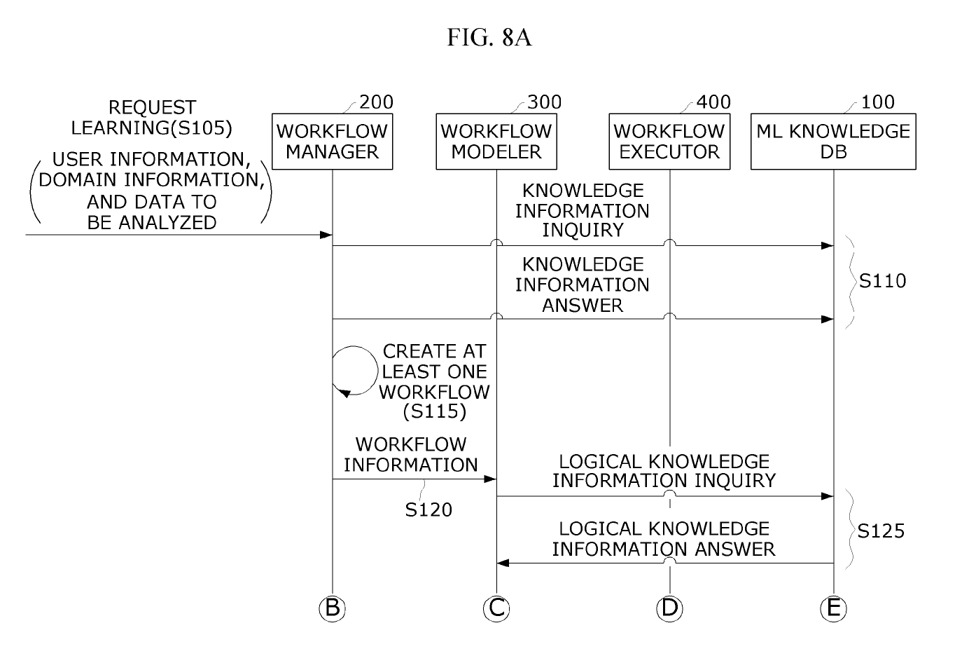

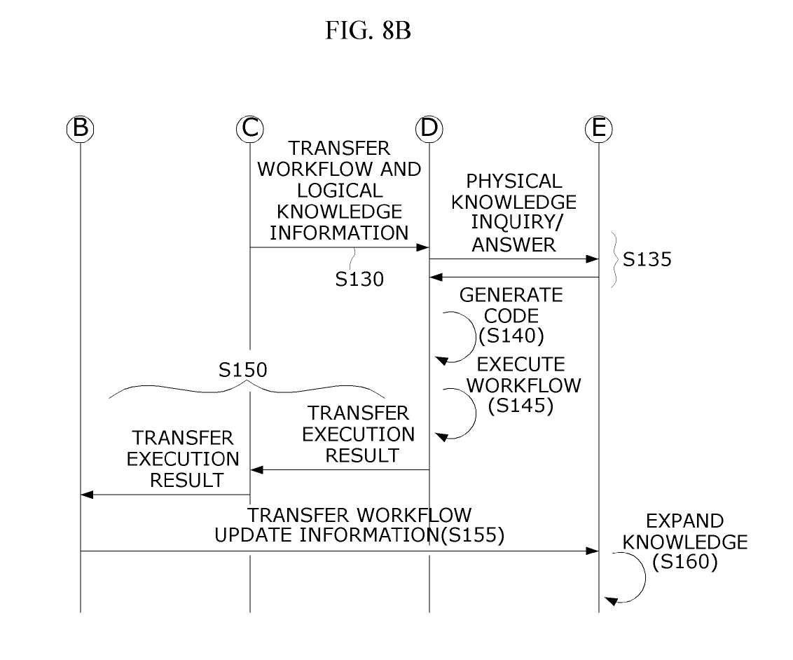

A process of creating a workflow in the self-learning system 1 according to an exemplary embodiment of the present invention will be described in further detail below with reference to FIG. 8.

FIGS. 8A and 8B are a sequence diagram illustrating operation of the self-learning system 1 based on ML knowledge and an automated workflow according to an exemplary embodiment of the present invention.

Referring to FIG. 8, the workflow manager 200 receives user request information from a user who requests generation of a workflow (S105). The user request information may include user information, such as user identification information and user type information, domain information including an analysis-target domain type and the like, and data to be analyzed.

Here, the user type, since it is information classified according to user level based on knowledge of ML, may be that of a general user, a domain expert, an ML expert, a system engineer, and the like. The domain type, since it is information classified according to application field, may be, for example, that of health, facilities, energy, and the like.

Next, the workflow manager 200 inquires the ML knowledge DB 100 about related knowledge based on the received user request information (S110).

Here, the knowledge inquiry may be performed in the form of a question and an answer. Specifically, the workflow manager 200 checks the user knowledge 110 corresponding to the user type, the domain knowledge 120 and the guide knowledge 130 corresponding to the analysis-target domain type, and extracts one or more related pieces of the workflow knowledge 140 based on the checked user knowledge 110, domain knowledge 120, and guide knowledge 130.

Next, the workflow manager 200 creates at least one workflow appropriate for the user type and the domain type based on the inquired knowledge (S115). Here, the workflow manager 200 may inquire the ML knowledge DB 100 about at least one workflow appropriate for the user type and the domain type and create at least one workflow by setting an option (an attribute and the like) of the inquired workflow.

Meanwhile, when no workflow corresponds to the user type and the domain type requested by the user in the ML knowledge DB 100, the workflow manager 200 may request all knowledge applicable to the domain type and create a plurality of workflows.

Next, the workflow manager 200 transfers the created at least one workflow to the workflow modeler 300 (S120).

Subsequently, to concretize each workflow received from the workflow manager 200 to a logical knowledge level, the workflow modeler 300 inquires the ML knowledge DB 100 about logical knowledge related to a function of each node through a question and answer process (S125). Here, the question and answer may be provided through the workflow manager 200. In addition, the workflow modeler 300 may add a hyperparameter tuning function to the workflow to optimize performance.

Next, the workflow modeler 300 concretizes the at least one workflow to the function level based on logical knowledge received from the ML knowledge DB 100, and then transfers the concretized workflow to the workflow executor 400 so that the workflow is actually executed (S130).

The workflow executor 400 inquires the ML knowledge DB 100 about physical knowledge matched to each function of the concretized workflow and receives the physical knowledge (S135).

Next, the workflow executor 400 converts the at least one workflow to the execution code level using the physical knowledge library (S140) and executes the workflow (S145).

An execution result of the workflow executor 400 and the workflow modeler 300 is transferred to the workflow manager 200 (S150), and the workflow manager 200 extracts and transfers update information based on an execution result of at least one previously created workflow to the ML knowledge DB 100 (S155). Here, each workflow is modeled and executed by the workflow modeler 300 and the workflow executor 400, respectively. Performance information such as accuracy, learning time, prediction time, and other considerations is derived by analyzing the execution result of the workflow modeler 300 and the workflow executor 400, and is compared to select and provide a workflow appropriate for the user type and the domain type.

The workflow-related knowledge fed back in this way is accumulated in the ML knowledge DB 100 such that knowledge is expanded (S160).

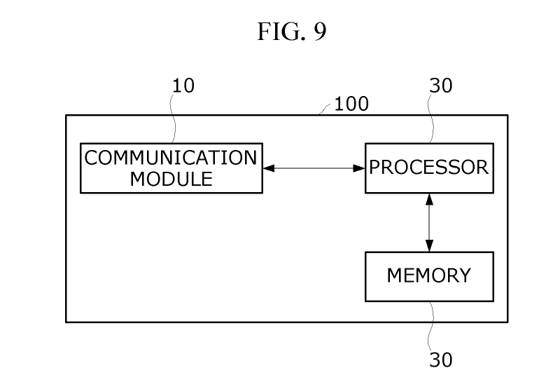

FIG. 9 is a diagram showing a configuration of the self-learning system 1 according to an exemplary embodiment of the present invention.

The self-learning system 1 according to an exemplary embodiment of the present invention may include a communication module 10, a memory 20, and a processor 30.

The communication module 10 is an element for exchanging data with external devices and apparatuses, and may include both a wired communication module and a wireless communication module. The wired communication module may be implemented through a power-line communication device, a telephone-line communication device, CableHome (multimedia over coax alliance (MoCA)), Ethernet, institute of electrical and electronics engineers (IEEE) 1294, an integrated wired home network, and an RS-485 control apparatus. Also, the wireless communication module may be implemented through wireless local area network (WLAN), Bluetooth, high data rate (HDR) wireless personal area network (WPAN), ultra-wideband (UWB), ZigBee, impulse radio, 60 GHz WPAN, binary-code division multiple access (CDMA), wireless universal serial bus (USB), and wireless high definition multimedia interface (HDMI) technologies, and the like.

The memory 20 stores a program for operating the workflow-based self-learning system 1. Here, the memory 20 is a common designation for a non-volatile storage device which continuously maintains stored information even when power is not supplied and for a volatile storage device.

For example, the memory 20 may include a NAND flash memory such as a compact flash (CF) card, a secure digital (SD) card, a memory stick, a solid-state drive (SSD), and a micro SD card, a magnetic computer storage device such as a hard disk drive (HDD), an optical disk drive such as a compact disk-read only memory (CD-ROM) and digital versatile disk (DVD)-ROM, and the like.

The processor 30 executes the program stored in the memory 20. When executing the program, the processor 30 may manage the ML knowledge DB 100 described above with reference to FIGS. 1 to 8 and may cause the workflow manager 200, the workflow modeler 300, and the workflow executor 400 to perform their functions.

Each element and operation of the self-learning system 1 according to an exemplary embodiment of the present invention may be implemented in the form of software which is readable by various computing means, recorded in a computer-readable recording medium, and then executed to be implemented by at least one processor. Here, the recording medium may include program instructions, data files, data structures, and the like separately or in combination. The program instructions stored on the recording medium may be specially designed and configured for the present invention, or may be known to and available for those of ordinary skill in the computer software field. Examples of the recording medium include magnetic media, such as a hard disk, a floppy disk, and a magnetic tape, optical media, such as a CD-ROM and a DVD, magneto-optical media, such as a floptical disk, and hardware devices, such as a ROM, a random access memory (RAM), and a flash memory, which are specially configured to store and execute program instructions. Examples of the program instructions include not only a machine language code generated by a compiler but also a high-level language code which is executable by a computer using an interpreter or the like. Such a hardware device may be configured to operate as one or more software modules to perform operations of the present invention, and vice versa.

The processor which implements the self-learning system according to an exemplary embodiment of the present invention may process program instructions for a method according to an exemplary embodiment of the present invention. In an implementation example, the processor may be a single-threaded processor. In another implementation example, the processor may be a multi-threaded processor. The processor is able to process an instruction stored in the memory or the storage device.

The self-learning system according to an exemplary embodiment of the present invention may be implemented in a distributed manner over a network, such as a server farm, or may be implemented in a single computer device.

According to exemplary embodiments of the present invention, it is possible to accumulate knowledge related to ML in an ML knowledge DB, automatically create or recommend an appropriate workflow for various users and domains based on the accumulated knowledge, and execute, evaluate, store, and share previously created workflows using various algorithms.

More specifically, according to exemplary embodiments of the present invention, it is possible to abstract and transform each function of a workflow such as preprocessing, learning, prediction, and knowledge improvement, possible to enhance knowledge by receiving a result of executing a workflow created based on the knowledge, and possible to provide recommendation information using the enhanced knowledge when a user creates a workflow.

Also, according to exemplary embodiments of the present invention, a thesaurus for ML is constructed and updated, and a workflow and functions are abstracted and stratified based on the type of user, which includes expert, non-expert, engineer, and the like, and are also stratified based on the type of domain, which includes healthcare, factory, energy, home, building, office, and the like, and are mapped to a library of an ML engine so that users of various levels may be supported in creating and executing workflows suitable for their purposes with minimal knowledge.

Further, according to exemplary embodiments of the present invention, even when data, a domain, details to be learned, and the like input by a user are not transformed in advance into knowledge for a workflow, it is possible to recommend an optimal workflow by generating a plurality of workflows in consideration of all applicable procedures and settings, executing the workflows separately or in conjunction with each other, and then analyzing and evaluating the results.

Consequently, according to exemplary embodiments of the present invention, workflows, which are separately created and managed according to user in the related art, are standardized and transformed into knowledge such that various users may share the workflows, and user- and domain-specific knowledge is enhanced through a virtuous cycle such that many users may easily generate and manage workflows.

Although a configuration of an exemplary device has been described in the specification and drawings, implementations of the functional operations and the subject matter described in the specification may be implemented in other types of digital electronic circuits, implemented in computer software, firmware, or hardware including the structures disclosed in the specification and structural equivalents thereof, or implemented in a combination of one or more thereof. The subject matter described in the specification may be implemented in one or more computer program products, that is, one or more modules related to a computer program instruction encoded on a tangible program storage medium to control an operation of an apparatus or the execution by the operation. A computer-readable medium may be a machine-readable storage device, a machine-readable storage substrate, a memory device, a composition of materials influencing a machine-readable radio wave signal, or a combination of one or more thereof.

In particular, in the present invention, the term “system” encompasses, for example, a programmable processor, a computer, or all kinds of tools, apparatuses, and machines including multiple processors or computers to process data. The system may include, in addition to hardware, a code that creates an execution environment for a computer program when requested, such as a code constituting processor firmware, a protocol stack, a DB management system, an OS, or a combination of one or more thereof.

A computer program (also known as a program, software, software application, script, or code) may be written in any form of programming language including compiled or interpreted languages, or declarative or procedural languages, and it may be deployed in any form including as a stand-alone program or module, a component, subroutine, or another unit suitable for use in a computer environment. A computer program may, but need not, correspond to a file in a file system. A program may be stored in a single file provided to the requested program, in multiple coordinated files (e.g., files storing one or more modules, sub-programs, or portions of code), or in a portion of a file which holds other programs or data (e.g., one or more scripts stored in a markup language document). A computer program may be deployed to be executed on one computer or multiple computers which are at one site or distributed across a plurality of sites and interconnected via a communication network.

The subject matter described in the specification may be implemented in a calculation system including a back-end component, such as a data server, a middleware component, such as an application server, a front-end component, such as a client computer having a web browser or a graphical user interface (GUI) which may interact with the implementations of the subject matter described in the specification by the user, or all combinations of one or more of the back-end, middleware, and front-end components. The components of the system may be interconnected by any type or medium of digital data communication such as a communication network.

While the specification contains many details of specific implementations, these should not be construed as limitations on the scope of any invention or of what may be claimed, but rather as descriptions of features that may be specific to particular embodiments of particular inventions. Specific features described in the specification in the context of separate embodiments may also be implemented in combination in a single embodiment. Conversely, various features described in the context of a single embodiment may also be implemented in multiple embodiments separately or in any suitable sub-combination. Furthermore, although features may be described above as acting in specific combinations and even initially claimed as such, one or more features from a claimed combination may in some cases be excluded from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In specific circumstances, multitasking and parallel processing may be advantageous. Also, the separation of various system components in the embodiments described above should not be understood as required in all embodiments, and it should be understood that described program components and systems may be generally integrated together in a single software product or packaged into multiple software products.

Particular embodiments of the subject matter of the specification has been described. Other embodiments fall within the scope of the following claims. For example, the operations recited in the claims may be performed in a different order and still achieve desirable results. As an example, a process illustrated in the accompanying drawings does not necessarily require the specific order shown or a sequential order to achieve desirable results. In specific implementations, multitasking and parallel processing may be advantageous.

The description suggests the best mode of the present invention and provides examples that explain the present invention and also enable those of ordinary skill in the art to implement and use the present invention. The specification drafted as such is not limited to detailed terms suggested therein. Therefore, it will be apparent to those of ordinary skill in the art that various modifications, changes, and variations may be made in the described examples without departing from the scope of the present invention.

Accordingly, the scope of the present invention should be defined not by the described embodiments but by the claims.

What is claimed is:

1. A self-learning system for automatically performing machine learning (ML), the system comprising:
a memory configured to store an ML knowledge database (DB) in which ML knowledge is stored and a program for automatically performing ML based on request information of a user; and
a processor configured to execute the program stored in the memory,
wherein when executing the program, the processor creates or recommends at least one workflow corresponding to the request information of the user based on the ML knowledge stored in the ML knowledge DB and generates an execution code for performing the created or recommended workflow.

2. The self-learning system of claim 1, wherein the ML knowledge DB includes at least one of user knowledge obtained by transforming scope of modification in workflow based on user type into knowledge, domain knowledge obtained by transforming scope of modification in workflow based on features of analysis-target domains into knowledge, guide knowledge in which information structures for generating workflow steps are defined, and workflow knowledge obtained by transforming applicable workflows based on user type and domain type into knowledge.

3. The self-learning system of claim 2, wherein the processor creates at least one workflow corresponding to the request information of the user based on at least one of the user knowledge, the domain knowledge, the guide knowledge, and the workflow knowledge.

4. The self-learning system of claim 2, wherein the user knowledge is structured to include user type information, user operating environment information, and setting depth information for defining user-setting ranges of workflow or automatic-setting workflow ranges based on users and user type.

5. The self-learning system of claim 2, wherein the domain knowledge is structured to include domain type information and problem type information indicating a type of a problem to be solved by the domain type.

6. The self-learning system of claim 2, wherein the guide knowledge is structured to include at least one of location information knowledge, data condition knowledge, model restriction knowledge, execution restriction knowledge, and use-experience knowledge.

7. The self-learning system of claim 6, wherein the location information knowledge includes at least one of a data storage location required to perform the workflow and an access route of a software package,
the data condition knowledge includes at least one of a specific workflow for defining the workflow, a specific model element, and information on input and output data conditions of a specific class,
the model restriction knowledge includes knowledge for restricting executable workflows or executable ML models,
the execution restriction knowledge includes at least one of domain restriction knowledge, data restriction knowledge, memory restriction knowledge, and hardware restriction knowledge about a specific ML model, and
the use-experience knowledge includes at least one of a prediction type, frequencies of use of ML models, a label, and information about whether a label is necessary.

8. The self-learning system of claim 6, wherein the guide knowledge has an if-then-else structure with regard to the model restriction knowledge and the execution restriction knowledge, and
the processor automatically obtains the restriction knowledge through information on a result of performing the workflow.

9. The self-learning system of claim 2, wherein the workflow knowledge comprises a plurality of nodes for defining individual unit functions constituting the workflow, attribute information of the nodes, and inter-node connection information.

10. The self-learning system of claim 9, wherein the plurality of nodes include at least two of a task starting node, a data processing node, a conditional branch node, and a task ending node.

11. The self-learning system of claim 2, wherein the ML knowledge DB further includes logical knowledge obtained by transforming a function available in the workflow into knowledge, and
the processor concretizes the created workflow to a logical knowledge level based on the logical knowledge.

12. The self-learning system of claim 11, wherein the logical knowledge is mapped to 0 or more entities of physical knowledge.

13. The self-learning system of claim 2, wherein the ML knowledge DB further includes physical knowledge for defining model elements at a software library level available in the workflow, and
the processor generates the execution code of the workflow based on the physical knowledge.

14. The self-learning system of claim 13, wherein the processor collects the request information of the user including an analysis-target domain type and a user type requested to be analyzed, creates or recommends at least one workflow corresponding to the request information of the user based on the ML knowledge DB, and generates the execution code based on the physical knowledge included in the ML knowledge DB.

15. The self-learning system of claim 14, wherein before generating the execution code, the processor concretizes the recommended at least one workflow to a logical knowledge level based on logical knowledge included in the ML knowledge DB, and converts the concretized workflow to an execution code level.

16. The self-learning system of claim 14, wherein the processor executes the at least one workflow based on the generated execution code and updates the ML knowledge DB by feeding back a result of the at least one workflow.

17. The self-learning system of claim 16, wherein when no workflow corresponds to the request information of the user in the ML knowledge DB, the processor creates a plurality of workflows applicable to the analysis-target domain type included in the request information of the user, analyzes performance of the created workflows by comparing results of performing the workflows, and selects and provides the at least one workflow to be recommended among the plurality of workflows.

18. A self-learning method for automatically performing machine learning (ML), the method comprising:
receiving request information of a user including a user type requested to be analyzed and an analysis-target domain type;
creating or recommending at least one workflow corresponding to the request information of the user based on ML knowledge stored in an ML knowledge database (DB); and
generating an execution code for performing the created or recommended workflow.

19. The self-learning method of claim 18, wherein the ML knowledge DB includes at least one of user knowledge obtained by transforming workflow ranges based on user type into knowledge, domain knowledge obtained by transforming workflow ranges based on features of analysis-target domains into knowledge, guide knowledge in which information structures for generating workflow steps of a workflow are defined, workflow knowledge obtained by transforming applicable workflows based on user type and domain type into knowledge, logical knowledge obtained by transforming functions available in the workflow into knowledge, and physical knowledge for defining model elements at a software library level available in the workflow.

20. The self-learning method of claim 19, wherein the creating or recommending of the at least one workflow comprises:
creating at least one workflow corresponding to the request information of the user based on at least one of the user knowledge, the domain knowledge, the guide knowledge, and the workflow knowledge; and
concretizing the created workflow to a logical knowledge level based on the logical knowledge, and
the generating of the execution code comprises generating the workflow execution code concretized to the logical knowledge level based on the physical knowledge.
